(19) United States
(12) Patent Application Publication
(10) Pub. No.: US 2023/0058684 A1
(43) Pub. Date: Feb. 23, 2023

(54) System and method for testing a Bluetooth low energy implementation under test

(71) Applicant: Rohde & Schwarz GmbH & Co. KG, München (DE)

(72) Inventor: Brian Glover, Aldershot (GB)

(21) Appl. No.: 17/405,192

(22) Filed: Aug. 18, 2021

(51) Int. Cl. H04W 24/08; H04W 4/80; H04W 76/14

(52) U.S. Cl. CPC H04W 24/08; H04W 4/80; H04W 76/14

(57) ABSTRACT

The present invention provides an enhanced testing of Bluetooth Low Energy implementations by means of a non-signaling test device. A BLE device establishes a BLE connection with the implementation under test, and a non-signaling test device which is communicatively coupled with the BLE device listens on the established communication.

### TECHNICAL FIELD

The present invention relates to a system for testing a Bluetooth low energy implementation under test. The present invention further relates to a method for testing a Bluetooth low energy implementation under test.

### BACKGROUND

Bluetooth Low Energy (BLE) is a new wireless communication technology published by the Bluetooth special interest group (SIG) as component of Bluetooth core specification version 4.0. BLE is a low power, low complexity and lower cost wireless communication protocol, designed for applications requiring lower data rates and lower duty cycles. BLE technology is aimed at devices requiring low power consumption, for example devices that may operate with small batteries. BLE can also be incorporated into devices such as mobile phones, smartphones, tablet computers, laptop computers or desktop computers.

During development or production of devices with a BLE implementation, specific tests have to be performed. Such tests are needed to make sure that the BLE device complies with the desired requirements.

Many test cases for performing Bluetooth-based radio frequency (RF) physical layer (PHY) evaluation requires complex test devices including a signaling tester for establishing a communication link with the device under test. Hence, non-signaling testers cannot be used for such test scenarios.

### SUMMARY

Against this background, the present invention aims to provide a test system and test method for testing Bluetooth-based RF PHY test operations by means of non-signaling test devices. In particular, the present invention aims to provide a test system and test method for performing Bluetooth Low Energy RF PHY test cases using a non-signaling test device.

The present invention therefore provides a test system and a test method with the features of the independent claims. Further advantageous embodiments are subject matter of the dependent claims.

According to a first aspect, a system for testing a Bluetooth Low Energy (BLE) implementation under test (IUT) is provided. The system comprises a BLE device and a test device. The BLE device is configured to establish a BLE communication between the BLE device and the IUT. The test device is communicatively coupled with the BLE device. The test device is configured to listen to the established communication between the BLE device and the IUT.

According to a further aspect, a method for testing a BLE IUT is provided. The method comprises providing a BLE device and a test device, and communicatively coupling the test device and the BLE device. The method further comprises establishing, by the BLE device, a BLE communication between the BLE device and the IUT. The method further comprises listening, by the test device, to the established communication between the BLE device and the IUT.

The present invention is based on the finding that many tests for Bluetooth devices require tests in a realistic environment. For this purpose, a communication connection, especially a Bluetooth/BLE link has to be established between at least two devices. During these tests, a master provides a signaling of parameters to the implementation under test. However, if the signaling is performed by a specialized test device complex and expensive test devices are required for providing the signaling capabilities.

The present invention therefore aims to provide a system and a method for perform Bluetooth RF PHY tests with test devices which do not provide signaling capabilities. Accordingly, the test device only listens to the data, in particular to RF PHY packets, on a communication link established with an implementation under test. In the following, test devices without the capabilities for providing a signaling are named as non-signaling test devices. Such non-signaling test devices may only listen to a communication established between two (or more) communication partners. Especially a non-signaling test device will not actively send signals on the communication connection between the communication partners.

In order to perform Bluetooth RF PHY tests with non-signaling test devices, the present invention makes use of an additional Bluetooth device. This additional Bluetooth device is communicatively coupled with the non-signaling test device. The additional Bluetooth device provides the signaling capabilities for establishing a Bluetooth communication link with the implementation under test. In particular, the additional Bluetooth device may be controlled by the non-signaling test device via the established communication between the test device and the additional Bluetooth device. In this way, it is possible to perform RF PHY tests by means of test devices which do not provide the signaling capabilities. In particular, such tests may be used for testing Bluetooth Low Energy implementations. For example, a Rohde & Schwarz® CMW 100 may be used as a test device, in particular as non-signaling test device. However, any other appropriate test device may be used, too.

The additional Bluetooth device may be any kind of appropriate Bluetooth device which can establish a Bluetooth communication link with the IUT and provide the required signaling capabilities for the test procedure. Furthermore, the Bluetooth device may comprise an appropriate interface for communicatively coupling the Bluetooth device with the test device. For example, the test device and the Bluetooth device may be communicatively coupled by a wired connection such as a communication bus or the like. In particular, the Bluetooth device and the test device may be communicatively coupled by a host controller interface.

For example, the Bluetooth device may be a so-called “golden device”. Golden devices are well-known devices in many technical fields. A golden device may be conventional device, for example a device from a standard production line. Especially, golden devices may be devices which are used in conjunction with devices or implementations under test in order to test an interaction between the golden device and the device or implementation under test. However, any other appropriate Bluetooth device, in particular BLE device, may be used, too.

As already mentioned above, the test device may be a non-signaling test device, i.e. a test device which does not provide signaling capabilities. Since the communication link is established between the Bluetooth device and the implementation under test, the test device may only listen to the communication link. Accordingly, the test device does not emit any signals on the established communication link. Moreover, data transmission between the Bluetooth device and the IUT is only performed by transmission of signals by the Bluetooth device and the IUT.

In particular, the test device may filter out RF PHY packets, e.g., RF PHY packets from the IUT, and evaluate the test procedure based on the received RF PHY packets.

Since the testing of the IUT may be subjected to BLE IUT, the Bluetooth device may be a BLE device.

Further embodiments of the present invention are subject of the further subclaims and of the following description, referring to the drawings.

In a possible embodiment, the BLE device and the test device are communicatively coupled by a wired connection link. In particular, the BLE device and the test device may be communicatively coupled by a host controller interface (HCI). By communicatively coupling the BLE device and the test device, the test device may control the operation of the BLE device. In particular, the test device may send appropriate instructions to the BLE device in order to establish the BLE communication link with the IUT. Accordingly, a BLE communication link between the BLE device and the IUT is controlled by the test device even though the test device does not provide signaling capabilities. Especially by using a host controller interface, an appropriate control of the BLE device by the test device can be performed.

In a possible embodiment, the test device is a non-signaling test device. Accordingly, the test device does not have signaling capabilities, and the test device is not in the position to establish a Bluetooth communication link, in particular a BLE communication link with the IUT by itself. The test device may not actively transmit any data or signals on the established communication connection between the BLE device and the IUT. Especially, the test device may only receive date/signals transmitted between the BLE device and the IUT. IN a possible embodiment, the test device may receive only data or RF signals, especially RF PHY packets which are sent by the IUT. Nevertheless, by controlling the BLE device, the test device may cause the BLE device to establish a BLE communication link with the IUT. In this way, the test device may listen to the established communication between the BLE device and the IUT in order to perform appropriate measurements. In this way, the IUT can be tested by means of a broadly available, simple test device without signaling capabilities.

In a possible embodiment, the test device is configured to receive RF PHY test packets. Especially, the test device may listen on the established connection between the BLE device and the IUT and apply a filtering in order to obtain RF PHY test packets which are exchanged between the BLE device and the IUT. In particular, the test device may only receive or measure RF PHY packets which are sent be the IUT. In this way, the test device may evaluate and analyze the RF PHY test packets for testing purposes.

In a possible embodiment, the BLE device is configured to implement a link layer of the connection established between the BLE device and the IUT. By running the link layer on the BLE device, the BLE device may perform a signaling in real time.

In a possible embodiment, the BLE device is configured to establish an Asynchronous Connection-Less connection with the IUT.

In a possible embodiment, the communication connection between the BLE device and the IUT is a bidirectional connection. Accordingly, both the BLE device and the IUT may transmit and receive data to/from each other.

In a possible embodiment, the BLE device is configured to establish a wired RF connection with the IUT. For example, an RF signal may be provided to an antenna connector of the IUT. Accordingly, the wired connection may be also connected to an antenna connector of the BLE device. In this way, a wired RF connection may be established between the BLE device and the IUT even though such devices usually do not provide physical terminals for data transfer.

In an alternative embodiment, the BLE device is configured to establish a wireless RF connection with the IUT.

In a possible embodiment, the testing of the IUT is performed in a BLE test mode. For example, a special signaling test mode may be operated for testing the IUT. By operating the test procedure in a BLE test mode, Bluetooth devices can be tested even though the respective Bluetooth device does not have a physical interface connection.

With the present invention it is therefore now possible to perform a testing of Bluetooth devices, in particular BLE devices, by means of a broadly available non-signaling test device. For this purpose, a communication connection between the IUT and a more or less conventional communication partner such as a golden device or another BLE implementation is established.

After establishing the Bluetooth communication, the non-signaling test device may perform measurements and an analysis by only listening on of the communication. Hence, the test device does not actively transmit signals on the established communication link.

### BRIEF DESCRIPTION OF THE DRAWINGS

For a more complete understanding of the present invention and advantages thereof, reference is now made to the following description taking in conjunction with the accompanying drawings. The invention is explained in more detail below using exemplary embodiments, which are specified in the schematic figures and the drawings, in which:

FIG. 1: shows a schematic block diagram of a system for testing a BLE implementation under test according to an embodiment; and

FIG. 2: shows a flow diagram illustrating a method for testing a BLE implementation under test.

The appended drawings are intended to provide further understanding of the embodiments of the invention. They illustrate embodiments and, in conjunction with the description, help to explain principles and concepts of the invention. Other embodiments and many of the advantages mentioned become apparent in view of the drawings. The elements in the drawings are not necessarily shown to scale.

In the drawings, like, functionally equivalent and identically operating elements, features and components are provided with like reference signs in each case, unless stated otherwise.

### DESCRIPTION OF EMBODIMENTS

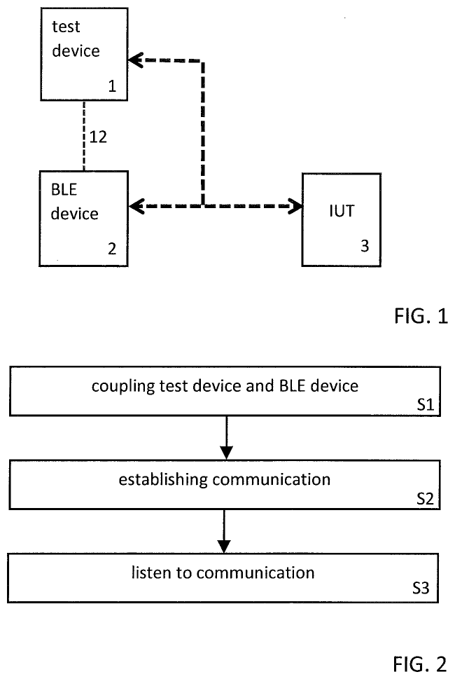

FIG. 1 shows a schematic block diagram of a system for testing Bluetooth Low Energy (BLE) implementations under test (IUT) 3. The system comprises a test device 1 and a BLE device 2. Test device 1 and BLE device 2 may be communicatively coupled with each other by a wired connection 12. For example, a host controller interface (HCI) may be used for communication between the test device 1 and the BLE device 2. In this way, the test device 1 and the BLE device 2 may communicate with each other. For example, the test device 1 may send commands to the BLE device 2 in order to cause the BLE device 2 to perform desired operations. Furthermore, test device 1 may read out one or more parameters of BLE device 2 or may receive any kind of data from BLE device 2.

Test device 1 may be a non-signaling test device. Accordingly, test device 1 does not have signaling capabilities. For example, test device 1 may be a CMW 100 of Rohde & Schwarz®. However, it is understood, that any other appropriate test device, in particular any other appropriate non-signaling test device may be possible, too. Such non-signaling test devices usually are used for production purposes.

In order to test the implementation under test (IUT) 3, BLE device 2 may establish a BLE communication between the BLE device 2 and the IUT 3. For this purpose, an Asynchronous Connection-Less (ACL) link may be established between the BLE device 2 and the IUT 3. The connection between the BLE device 2 and the IUT 3 may be established by a Bluetooth radio frequency connection, for example in the frequency range of 2.4 GHz.

The BLE connection between the BLE device 2 and the IUT 3 may be established by a wireless RF connection. Accordingly, wireless RF signals may be transmitted between antennas of the BLE device 2 and the IUT 3. Alternatively, it may be also possible to establish a wired connection between the BLE device 2 and the IUT 3. For example, a wired RF connection may be established between a terminal of the BLE device 2 and a terminal of the IUT 3. Especially, the RF wire of the wired connection may be connected to antenna terminals of the BLE device 2 and/or the IUT 3, respectively.

Furthermore, test device 1 may listen on the communication between the BLE device 2 and the IUT 3. Accordingly, if the connection between the BLE device 2 and the IUT 3 is established by a wireless communication, test device 1 may receive wireless RF signals of this communication. Alternatively, if the connection between the BLE device 2 and the IUT 3 is established by a wired RF connection, the RF signals of this communication may be also forwarded to the test device 1 by a wired connection.

By listening on the communication between the BLE device 2 and the IUT 3, test device 1 may receive the data packet exchange between the BLE device 2 and the IUT 3. During the communication between the BLE device 2 and the IUT 3, a number of test data packets may be exchanged between the BLE device 2 and the IUT 3. In particular, the IUT 3 may be caused to send a number of one or more test data packets. Test device 1 may receive the data packets exchanged between the BLE device 2 and the IUT 3. Especially, test device 1 may filter the received data packets in order to skip all data packets except of RF PHY test data packets sent by the IUT 3. Test device 1 may further measure and analyze the received and filtered RF PHY test packets. In this way, an appropriate measurement and testing of the IUT 3 can be performed by test device 1 even though test device 1 does not provide signaling capabilities.

BLE device 2 may be, for example a so-called “golden device”. For example, BLE device 2 may be a Nordic nRF5x development platform. However, any other kind of appropriate BLE device 2 may be possible, too. In this way, BLE device 2 may be used to either internally or externally act as a link handler or radio in connection with the non-signaling test device 1.

In a possible embodiment, a BLE host may be implemented in the test device 1, and a BLE controller may be implemented in the BLE device 2. In particular, BLE host and/or BLE controller may be realized by appropriate software.

For example, BLE device 2 may be operated to run a link layer of the BLE communication. In this way, it is possible to affect the signaling in real-time.

In a possible embodiment, a host stack may be operated in the test device 1. In this way, characteristics of the signal of the BLE device can be changed by the operation of the host stack.

The established BLE communication between the BLE device 2 and the IUT 3 may be a bidirectional communication. Accordingly, data packets may be transferred from the BLE device 2 to the IUT 3 and also from the IUT 3 to the BLE device 2.

FIG. 2 shows a flow diagram illustrating the method for testing a BLE IUT 2 according to an embodiment. It is understood, that the method for testing the BLE IUT 2 may comprise any method step for executing an operation as already described above in connection with the test system. Accordingly, the above-described test system may comprise any component in order to perform operations as will be described below in connection with the test method.

In step S1 the test device 1 may be communicatively coupled with the BLE device 2 by a wired connection link, in particular a host controller interface (HCI).

In step S2, a BLE device may establish a BLE communication between the BLE device 2 and the IUT 3.

After the BLE communication has been established, the test device 1 may listen in step S3 to the established communication between the BLE device 2 and the IUT 3. In particular, the test device 1 may be non-signaling test device, which only receives signals or data without actively transmitting signals on the established communication connection.

Accordingly, test device 1 may listen on the communication between the BLE device 2 and the IUT 3 and receive RF PHY test data packets. The test device 1 may filter out the received RF PHY test data packets and perform a measurement and analysis based on the RF PHY test data packets. For example, the received RF PHY test data packets may be analyzed in order to evaluate an operation of the IUT 3. Additionally, or alternatively, signal properties or an error rate of the received test data packets may be analyzed.

The operation for testing the IUT 3 may be performed, for example in a particular BLE test mode. For this purpose, the BLE test mode may be activated in the IUT 3 and after activating the test mode, the operation of the IUT 3 may be analyzed. In this way, IUT 3 may be tested even though no physical connection interfaces are provided for controlling or operating the IUT 3.

Summarizing, the present invention provides an enhanced testing of Bluetooth Low Energy implementations by means of a non-signaling test device. For this purpose, an additional BLE device is communicatively coupled with the non-signaling test device for establishing a BLE connection with the implementation under test.

In the foregoing detailed description, various features are grouped together in one or more examples or examples for the purpose of streamlining the disclosure. It is understood that the above description is intended to be illustrative, and not restrictive. It is intended to cover all alternatives, modifications and equivalents as may be included within the scope of the invention. Many other examples will be apparent to one skilled in the art upon reviewing the above specification.

Specific nomenclature used in the foregoing specification is used to provide a thorough understanding of the invention. However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects.

### LIST OF REFERENCE SIGNS

1 test device
2 BLE device
3 Implementation under test
12 Connection
S1, S2, S3 Method steps

1. A system for testing a Bluetooth Low Energy (BLE) implementation under test (IUT), the system comprising:
a BLE device for establishing a BLE communication between the BLE device and the IUT; and
a test device, communicatively coupled with the BLE device, and configured to listen to the established communication between the BLE device and the IUT.

2. The system of claim 1, wherein the BLE device and the test device are communicatively coupled by a wired connection link, in particular a Host Controller Interface (HCI).

3. The system of claim 1, wherein the test device is a non-signaling test device.

4. The system of claim 1, wherein the test device is configured to implement a host layer of the connection established between the BLE device and the IUT.

5. The system of claim 1, wherein the established BLE communication between the BLE device and the IUT is a bi-directional communication.

6. The system of claim 1, wherein the BLE device is configured to implement a link layer of the connection established between the BLE device and the IUT. 7 The system of claim 1, wherein the BLE device is configured to establish an Asynchronous Connection-Less connection with the IUT.

8. The system of claim 1, wherein the BLE device is configures to establish a wired RF connection with the IUT, in particular with an antenna connector of the IUT.

9. The system of claim 1, wherein the BLE device is configured to establish a wireless RF connection with the IUT.

10. The system of claim 1, wherein the connection between the BLE device and the IUT is operated in a BLE test mode.

11. A method for testing a Bluetooth Low Energy (BLE) implementation under test (IUT), the method comprising:
communicatively coupling a test device with a BLE device;
establishing, by the BLE device, a BLE communication between the BLE device and the IUT; and
listening, by the test device, to the established communication between the BLE device and the IUT.

12. The method of claim 11, wherein communicatively coupling the BLE device and the test device comprises coupling the BLE device and the test device by a wired connection link, in particular by a Host Controller Interface (HCI).

13. The method of claim 11, wherein the test device is operated as a non-signaling test device.

14. The method of claim 11, comprising providing, by the test device, a host layer of the connection established between the BLE device and the IUT.

15. The method of claim 11, wherein listening to the established communication between the BLE device and the IUT comprises receiving and filtering RF-PHY test packets transmitted via the established communication between the BLE device and the IUT.

16. The method of claim 11, comprising providing, by the BLE device, an implementation of a link layer of the connection established between the BLE device and the IUT.

17. The method of claim 11, wherein establishing the BLE communication between the BLE device and the IUT comprises establishing an Asynchronous Connection-Less connection with the IUT.

18. The method of claim 11, wherein the BLE communication between the BLE device and the IUT is established by a wired RF connection, in particular with an antenna connector of the IUT.

19. The method of claim 11, wherein the BLE communication between the BLE device and the IUT is established by a wireless RF connection.

20. The method of claim 11, wherein the test method is operated in a BLE test mode of the BLE device and/or the IUT.
